(19) United States
(12) Patent Application Publication
(10) Pub. No.: US 2014/0006598 A1
(43) Pub. Date: Jan. 2, 2014

(54) METHODS, APPARATUSES AND COMPUTER PROGRAM PRODUCTS FOR FACILITATING DYNAMIC ORIGIN-BASED DOMAIN ALLOCATION

(71) Applicant: Juha Uola, Tampere (FI)

(72) Inventor: Juha Uola, Tampere (FI)

(73) Assignee: Nokia Corporation, Espoo (FI)

(21) Appl. No.: 13/538,597

(22) Filed: Jun. 29, 2012

(51) Int. Cl. G06F 15/173

(52) U.S. Cl. 709/224

(57) ABSTRACT

An apparatus for determining origins of applications may include a processor and memory storing executable computer program code that cause the apparatus to at least perform operations including determining one or more origins of one or more applications, received from a network device(s), during installation of the applications. The computer program code may cause the apparatus to create one or more virtual domains based in part on the determined origins of the applications. The computer program code may further cause the apparatus to include the applications belonging to a same origin in a same virtual domain of created virtual domains. The computer program code may further cause the apparatus to provide the applications, to a communication device and data indicating virtual domains that the applications are included within. The data may include a token enabling an application to access a resource(s). Corresponding methods and computer program products are also provided.

### TECHNOLOGICAL FIELD

An example embodiment of the invention relates generally to wireless communication technology and, more particularly, relates to a method, apparatus, and computer program product for providing an efficient and reliable mechanism of securing applications in a communications network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal.

Communication device users may access some of these interactive applications or other resources via a browser on a communication device. At present, browsers commonly implement a same-origin policy in which web pages are given permissions based on their load origin. For example, a user may allow a web page loaded from a particular web site to access device location data, whereas a web page loaded from another web site may deny access. In this regard, user trust may be bound to the organization hosting the web site.

At present, a mechanism such as virtual hosting may host multiple domain names (with separate handling of each name) on a single server (or pool of servers). This allows one server to share its resources, such as memory and processor cycles, without requiring all services provided to use the same host name.

There are two main types of virtual hosting, such as name based virtual hosting and Internet Protocol (IP) based virtual hosting. Name based virtual hosting generally uses the host name presented by a client device. This approach may save IP addresses and the associated administrative overhead but the protocol being served may need to supply the host name at an appropriate point. IP based virtual hosting may utilize a separate IP address for each host name, and IP based virtual hosting may be performed with any protocol but may require a dedicated IP address for each domain name being served.

Currently, some communication devices may virtual host applications and may provide one or more of the hosted applications to another communication device. At present, a problem may arise involving a mismatch of web security principles and the architecture being used in an instance in which a communication device hosting applications provides one or more of the hosted applications to another device(s) when requested. For instance, a communication device may host several applications that originate from various sources and each application may be given specific permissions based on their trust level. These permissions may be enforced by the browser of another communication device using the same-origin policy principle. However, if all applications are loaded from the same origin, all applications may get the same permissions in a browser of another communication device. Also several other browser features, such as local storage and cookies, may rely on distinct load origin.

As such, the same origin for different applications may result in all applications being able to access the same local storage and cookies, which may result in a security breach.

### BRIEF SUMMARY

A method, apparatus, and computer program product are therefore provided in accordance with an example embodiment to facilitate a more robust security system to enable applications to receive access to resources.

In an example embodiment, a communication device may load or provide one or more applications to another communication device, instead of loading the applications directly from a network device(s) that may be maintained by a source origin entity (e.g., organization (e.g., company)).

An example embodiment of the invention may generate one or more virtual domains that are allocated during installation of one or more of the loaded applications. Each of the virtual domains may include one or more applications that originated for a same source origin. Additionally, an example embodiment may associate one or more permissions, of an application(s) to resources, with a virtual domain-specific token and a communication device may manage access to one or more resources (e.g., secure resources) based on the token.

In one example embodiment, a method may include determining one or more respective origins of one or more applications, received from at least one network device, during installation of the applications. The method may further include creating one or more virtual domains based at least in part on the determined origins of the applications. The method may further include including the applications determined to belong to a same origin in a same virtual domain of the created virtual domains. The method may further include enabling provision of the applications, to a communication device and data indicating corresponding virtual domains that the respective applications are included within. The data may include a generated token that enables a corresponding application to access one or more resources.

In another example embodiment, an apparatus may include a processor and a memory including computer program code. The memory and computer program code are configured to, with the processor, cause the apparatus to at least perform operations including determining one or more respective origins of one or more applications, received from at least one network device, during installation of the applications. The memory and the computer program code are further configured to, with the processor, cause the apparatus to create one or more virtual domains based at least in part on the determined origins of the applications. The memory and the computer program code are further configured to, with the processor, cause the apparatus to include the applications determined to belong to a same origin in a same virtual domain of the created virtual domains. The memory and the computer program code are further configured to, with the processor, cause the apparatus to enable provision of the applications, to a communication device and data indicating corresponding virtual domains that the respective applications are included within. The data may include a generated token that enables a corresponding application to access one or more resources.

In another example embodiment, a computer program product may include at least one computer-readable storage medium having computer-readable program code portions stored therein. The computer-executable program code instructions may include program code instructions configured to determine one or more respective origins of one or more applications, received from at least one network device, during installation of the applications. The program code instructions may also create one or more virtual domains based at least in part on the determined origins of the applications. The program code instructions may also include the applications determined to belong to a same origin in a same virtual domain of the created virtual domains. The program code instructions may also enable provision of the applications, to a communication device and data indicating corresponding virtual domains that the respective applications are included within. The data may include a generated token that enables a corresponding application to access one or more resources.

In another example embodiment, an apparatus may include means for determining one or more respective origins of one or more applications, received from at least one network device, during installation of the applications. The apparatus may include means for creating one or more virtual domains based at least in part on the determined origins of the applications. The apparatus may include means for including the applications determined to belong to a same origin in a same virtual domain of the created virtual domains. The apparatus may include means for enabling provision of the applications, to a communication device and data indicating corresponding virtual domains that the respective applications are included within. The data may include a generated token that enables a corresponding application to access one or more resources.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a diagram of a system in which a browser of a device loads applications from various sites;

FIG. 2 is a diagram of a device including a browser that manages application permissions based on application load origin;

FIG. 3 is a diagram of a system in which an application received from an entity is being installed on a device;

FIG. 4 is a diagram of a system in which an application installed on a device is loaded from the device onto another device;

FIG. 5 is a diagram of a device including applications loaded from another device that are included in a same sandbox;

FIG. 6 is a diagram illustrating a database access manager that is unable to securely verify access request origins;

FIG. 7 is a schematic block diagram of a system according to an example embodiment of the invention;

FIG. 8 is a schematic block diagram of an apparatus according to an example embodiment of the invention;

FIG. 9 is a schematic block diagram of a network device according to an example embodiment of the invention;

FIG. 10 is a schematic block diagram of another system according to an example embodiment of the invention;

FIG. 11 is a schematic block diagram of a system according to another example embodiment of the invention;

FIG. 12 illustrates a flowchart for installing one or more applications according to an example embodiment of the invention; and

FIG. 13 illustrates a flowchart for determining origins of applications according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a “sandbox” or “sandboxes” may denote a security mechanism for separating running programs. A sandbox may prevent certain functions in an instance in which an application(s) (e.g., a web application(s)) is received and executed. In this regard, a sandbox may create an environment in which there may be limits on what resources an application may request or access. One or more sandboxes of an example embodiment may be utilized to determine sources or origins of one or more applications to enable the applications to receive one or more resources securely.

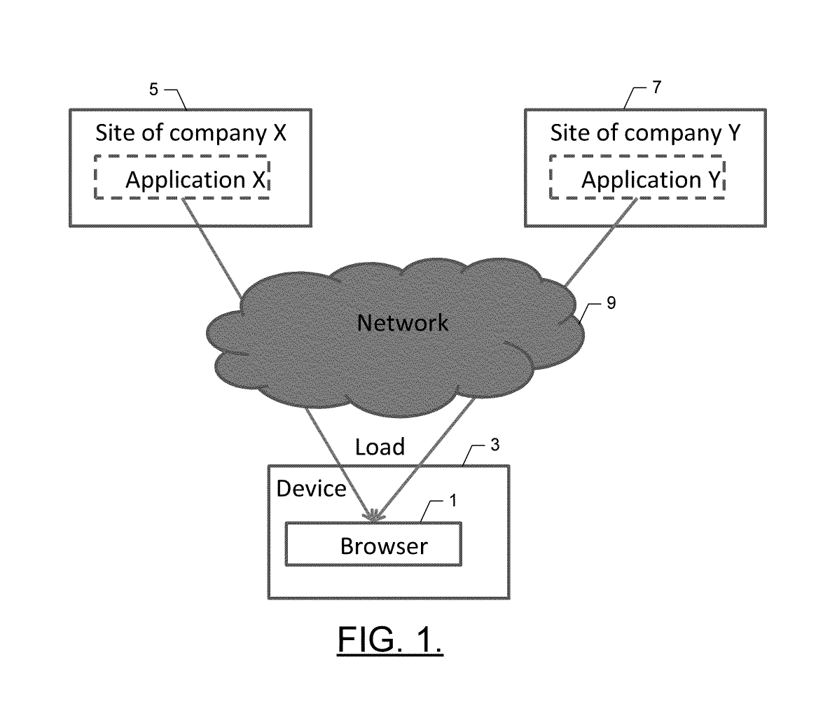

Referring now to FIG. 1, a diagram of a system is provided. In FIG. 1, a browser 1 of a device 3 may implement a same-origin policy and access application X from a host site of company X 5 and application Y from host site company Y 7 via network 9. The browser 1 may load application X and application Y and may execute applications X and Y.

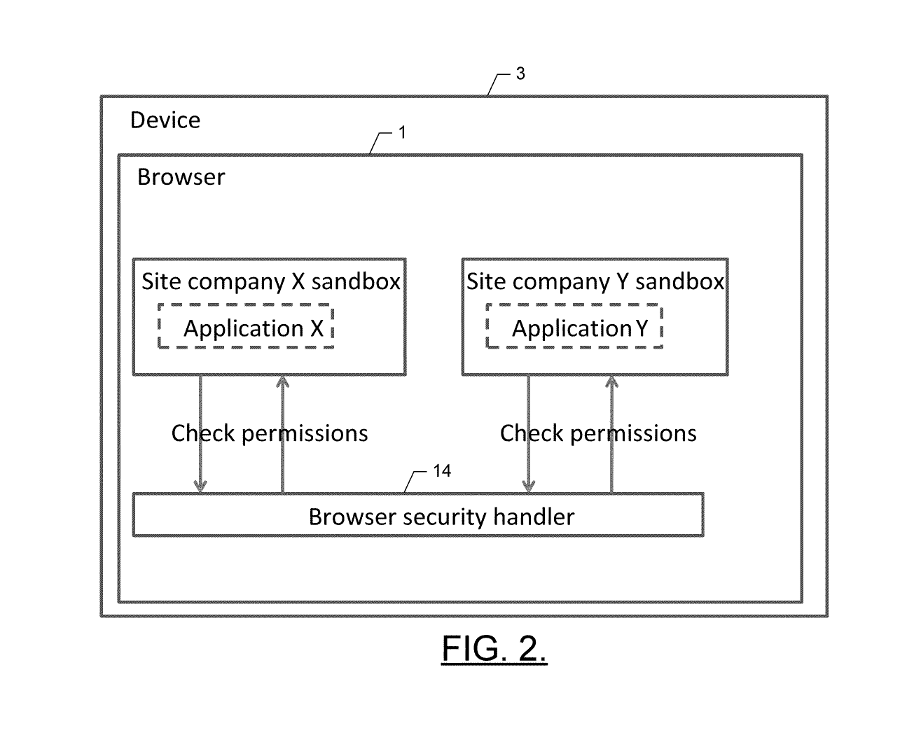

Referring now to FIG. 2, a diagram of a device with a browser managing applications is provided. In FIG. 2, the device 3 may receive one or more applications such as application X and application Y from different sites. The applications X and Y may be provided to browser 1 of device 3 with permissions based on their load origin (e.g., Site company X for application X, Site company Y for application Y). A browser security handler 14 of the browser 1 may manage and check the respective permissions associated with application X and application Y based on their load origin.

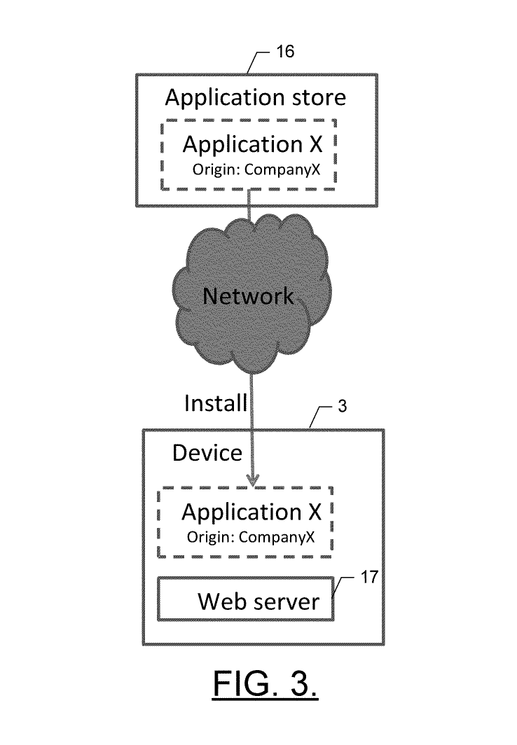

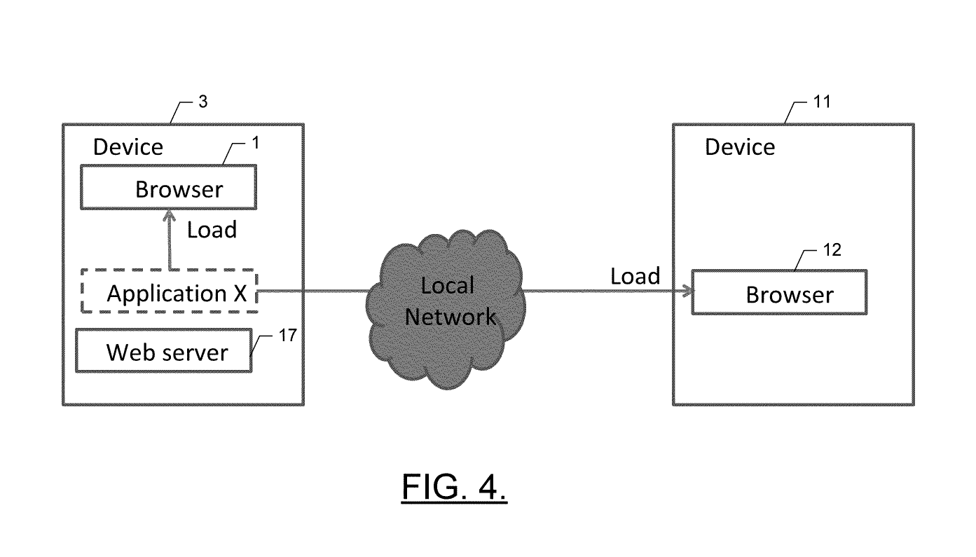

A problem or drawback may arise in currently existing architecture or systems in an instance in which a device such as, for example, device 3 hosting applications (e.g., application X, application Y) and serves or provides one or more of the applications to other devices (e.g., device 11) as needed. For instance, as shown in FIG. 3, an application (e.g., application X) produced by a company (e.g., of Company X) received from an application store 16 may be installed to device 3 and the device 3 may also use the application (e.g., application X). Device 3 may also provide the application to device 11 which may use the application (e.g., application X). The application (e.g., application X) may be, for example, a web application and device 3 may be running a web server 17 that is able to serve the application (e.g., application X). In an instance in which the application (e.g., application X) is installed to device 3, it may be copied to a directory that is served by a web server 17, as shown in FIG. 3. As shown in FIG. 4 devices 3 and 11 may be running browsers 1 and 12 (e.g., web browsers) that are each able to load a web application (e.g., application X) from the web server 17 of device 3 and may display the application. Although device 11 may be manufactured by any suitable entity and may run a browser (e.g., browser 12) from any suitable vendor, the browser 12 of device 11 may follow the common same-origin policy principle.

In FIG. 3, the web application (e.g., application X) may be packaged into a traditional installation package, and as such an installation phase may be similar to a current native application installation (e.g., like applications installed to a phone from Nokia™). During installation, the package may be unpacked and copied to a directory that may be served by the web server 17 of device 3. Application loading may then occur from this directory in the same manner as loading traditional web pages (as shown in FIG. 4).

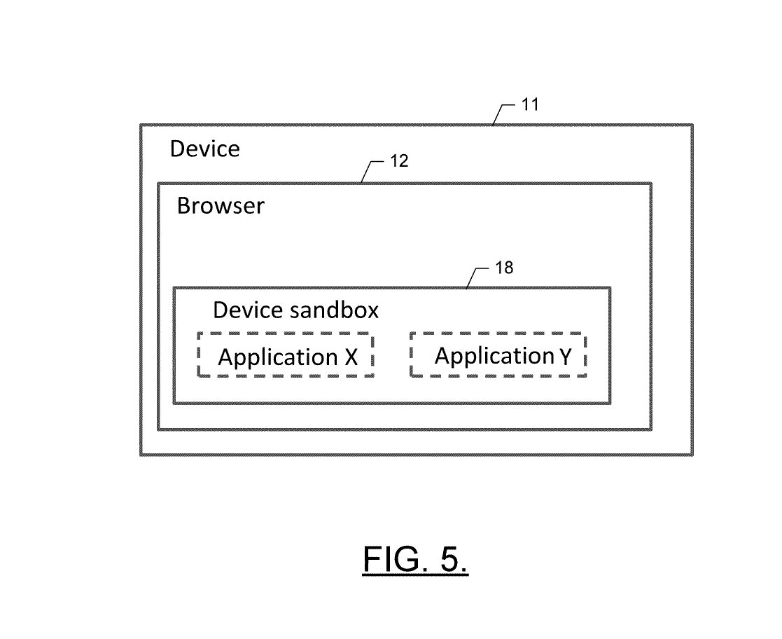

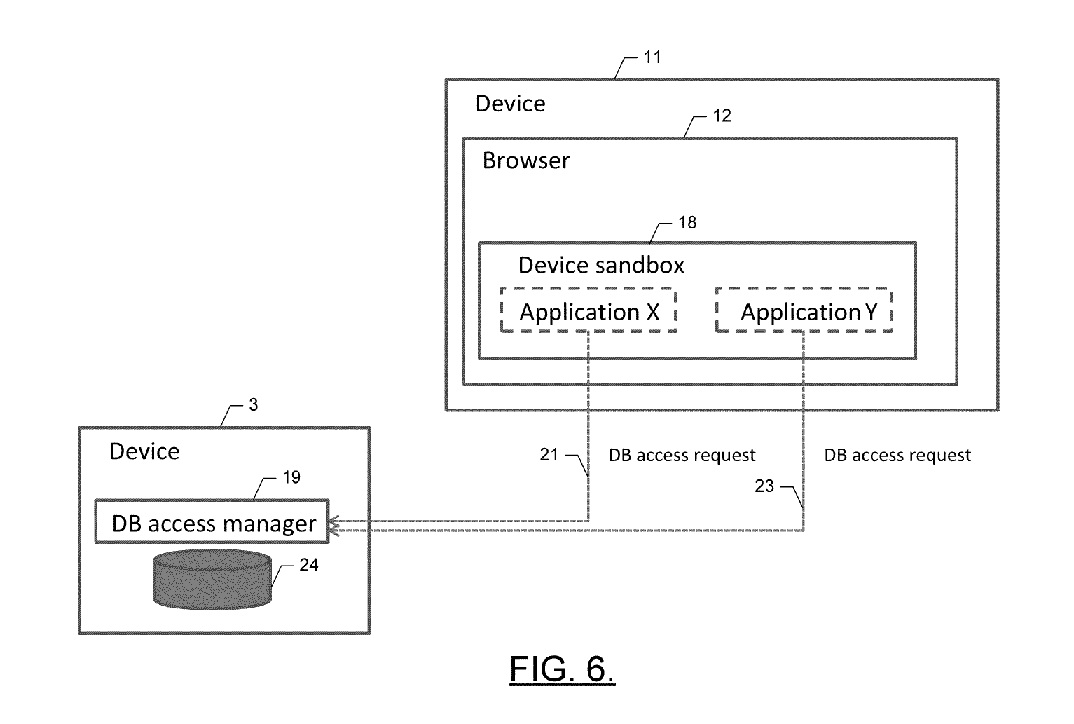

In some existing systems, a problem may arise based on the mismatch of web security principles and the used architecture. For instance, since device 3 may host several applications that originate from various sources (e.g., Site of company X, Site of company Y), each application may be given specific permissions based on their level of trust. These permissions may be enforced by the browser 12 of device 11 using the same-origin policy principle. However, if all applications are loaded from the same origin (e.g., the web server 17 of device 3), all applications may get the same sandbox (e.g., device sandbox 18) and thus the same permissions in the browser 12 of device 11, as shown in FIGS. 5 and 6. As such, the same origin for different applications (e.g., application X, application Y) may result in all applications being able to access the same local storage (e.g., local storage 24) and cookies, which may be a security breach. In addition, the database (DB) access manager 19 may be unable to securely verify the origins of DB access requests 21, 23 from applications (e.g., application X, application Y) of the device sandbox 18, as shown in FIG. 6 since the applications (e.g., application X, application Y) are part of the same sandbox (e.g., device sandbox 18) even though their origins are different (e.g., the Site of company X for application X, the Site of company Y for application Y).

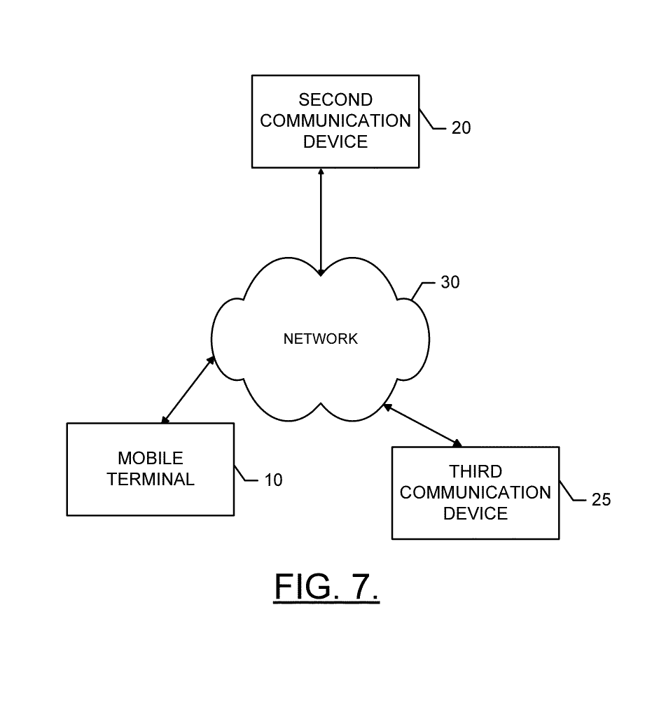

FIG. 7 illustrates a generic system diagram in which a device such as a mobile terminal 10 is shown in an example communication environment. As shown in FIG. 7, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 7 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 7 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 7, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an example embodiment, the second communication device 20 and the third communication device 25 may be network devices such as, for example, servers hosting applications (e.g., web applications). In this example embodiment, the mobile terminal 10 may receive one or more of the applications from the communication device 20 and/or the third communication device 25.

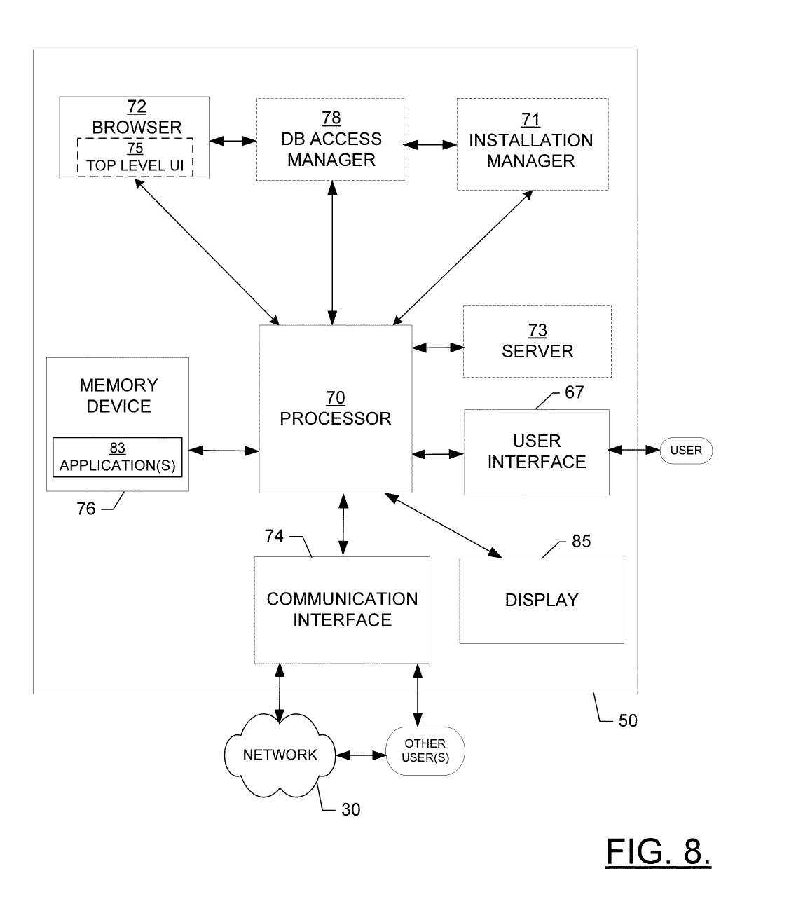

In another example embodiment, the mobile terminal as well as the second and third communication devices may employ an apparatus (e.g., apparatus of FIG. 8) capable of employing an embodiment of the invention.

FIG. 8 illustrates a schematic block diagram of an apparatus according to an example embodiment. An example embodiment of the invention will now be described with reference to FIG. 8, in which certain elements of an apparatus 50 are displayed. The apparatus 50 of FIG. 8 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 8, the apparatus 50 may include or otherwise be in communication with a processor 70, a user interface 67, a communication interface 74, a memory device 76, a display 85, an optional server 73 (e.g., a web server), a browser 72, an optional installation manager 71 and an optional database (DB) access manager 78. The browser 72 may include an optional top level user interface (UI) 75. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory.

The memory device 76 may be configured to store information, data, files, applications (e.g., software applications), instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.). The memory device 76 may also store one or more applications 83 (also referred to herein as application(s) 83). The application(s) 83 may, but need not be, be received from one or more network devices. The network devices may host applications (e.g., web applications).

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser 72, Web browser (e.g., Firefox™, Internet Explorer™, Google Chrome™, Safari™, etc.) or the like. In this regard, the connectivity program may enable the apparatus 50 to transmit and receive Web content, such as for example location-based content, applications (e.g., web applications) or any other suitable content, according to a Wireless Application Protocol (WAP), for example. The browser 72 may include an optional top level UI 75 which may load one or more applications from another communication device (e.g., another apparatus 50). In addition, the top level UI 75 may provide a token to an application in an instance in which the application is loaded and the top level UI 75 may perform other corresponding functions, as described more fully below.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

The server 73 may be any means such as a device or circuitry operating in accordance with software or otherwise embodied in hardware or a combination of hardware and software (e.g., processor 70) operating under software control, the processor 70 embodied as an ASIC or FPGA specifically configured to perform the operations described herein, or a combination thereof) thereby configuring the device or structure to perform the corresponding functions of the server 73, as described below.

For instance, the server 73 may provide one or more applications to another communication device (e.g., another apparatus 50). The server 73 may also provide one or more applications to browser 72. The server 73 may create one or more virtual domains and may include one or more applications in these virtual domains. In this regard, the server 73 may provide one or more of the applications from the created virtual domains to another communication device (e.g., another apparatus 50) and may perform other corresponding functions, as described more fully below.

The installation manager 71 may be embodied as the processor 70 (e.g., as an FGPA, ASIC, or the like). Additionally, the installation manager 71 may be any device or circuitry operating in accordance with software or otherwise embodied in hardware or a combination of hardware and software thereby configuring the device or circuitry to perform the corresponding functions of the installation manager 71, as described herein. For instance, the installation manager 71 may detect a source organization (e.g., Nokia™) of an application from a digital signature and may store granted permissions for the application in a permission registry. The installation manager 71 may also instruct the server 73 to create a virtual domain and copy the application(s) in the virtual domain, as well as perform other corresponding functions as described herein.

In an example embodiment, the processor 70 may be embodied as, include or otherwise control the DB access manager 78. The DB access manager 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the DB access manager 78, as described below. Thus, in an example in which software is employed, a device or circuitry (e.g., the processor 70 in one example) executing the software forms the structure associated with such means.

The DB access manager 78 may receive one or more requests for access to a memory (e.g., memory device 76) and/or a database of the memory. The access requests (also referred to herein as DB access requests) may be requests for information or resources associated with an application. The DB access manager 78 may check a received request for a security token in an instance in which an access request requires permissions, and may perform other corresponding functions, as described more fully below.

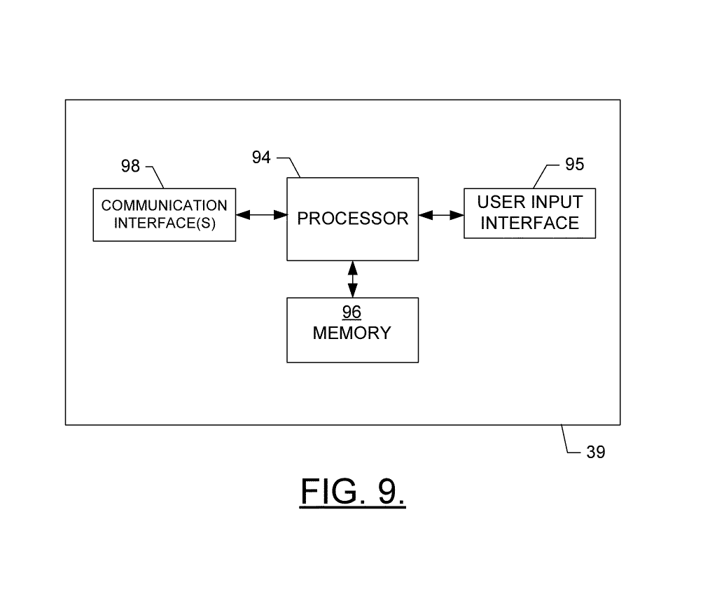

Referring now to FIG. 9, a block diagram of an example embodiment of a network entity, such as, for example, a network device is provided. As shown in FIG. 9, the network device 39 (e.g., a network server) generally includes a processor 94 and an associated memory 96. The memory 96 may comprise volatile and/or non-volatile memory, and may store content, data and/or the like. For example, the memory may store content, data, information, and/or the like transmitted from, and/or received by, the network device. Also for example, the memory 96 may store client applications (e.g., web applications), instructions, and/or the like for the processor 94 to perform the various operations of the network entity in accordance with embodiments of the invention, as described above.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the network entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The network device 39 may receive a request(s) from a browser (e.g., browser 72) for content (e.g., one or more applications). The network device 39 may, but need not, be a source entity or originator of the content (e.g., applications). In response to receipt of the request(s), the processor 94 of the network device 39 may provide the content to the browser of a communication device (e.g., apparatus 50). In one example embodiment, the network device 39 may include be a repository (also referred to herein as an application store) for storing or hosting one or more applications.

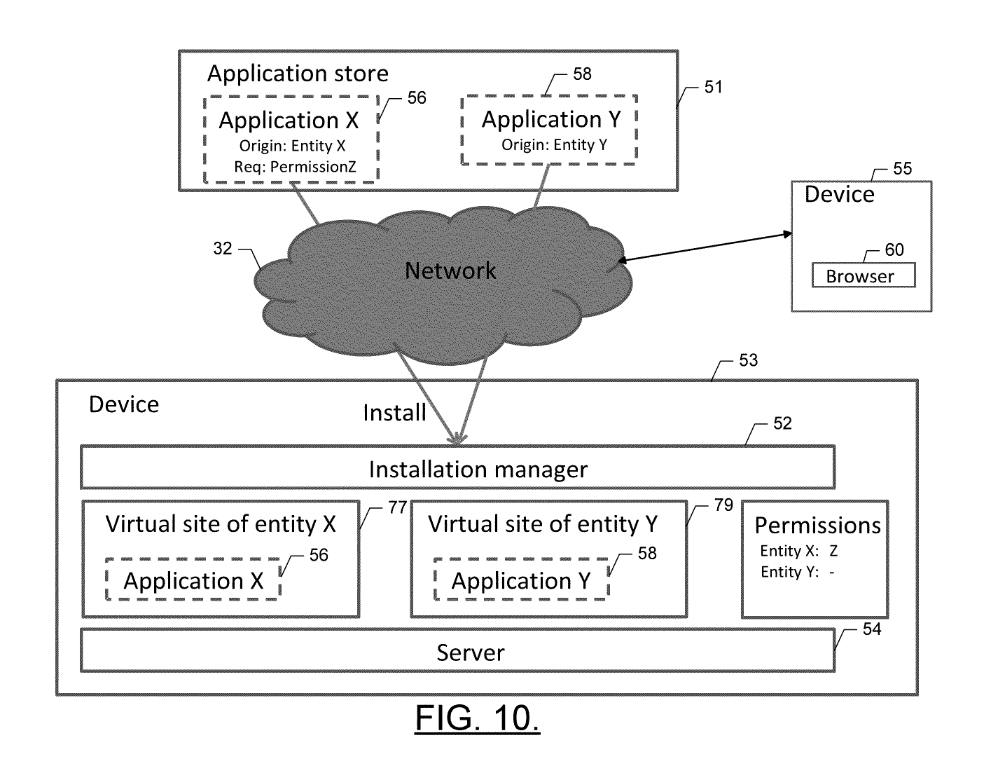

Referring now to FIG. 10, a system according to an example embodiment is provided. The system of FIG. 10 may include a network device 51 (e.g., network device 39) and communication devices 53 and 55 such as, for example, apparatuses 50. In the example embodiment of FIG. 10, the communication device 53 may include elements analogous to each of the elements of the apparatus 50. On the other hand, in the example embodiment of FIG. 10, the communication device 55 may not necessarily include an optional server (e.g., server 73), an optional DB access manager (e.g., DB access manager 78) and an optional installation manager (e.g., installation manager 71) but may include other elements analogous to the elements of apparatus 50. Although one network device 51 and two communications devices 53 and 55 are shown in FIG. 10, any suitable number of network devices may be part of the system of FIG. 10 without departing from the spirit and scope of the invention.

In the example embodiment of FIG. 10, the communication device 53 may request, via network 32 (e.g., network 30), one or more applications from a network device 51. The network device 51 may have a repository (e.g., an application store) for hosting one or more applications (e.g., application X 56, application Y 58) on behalf of one or more source entities (e.g., origin entity X, origin entity Y). The network device 51 may provide one or more applications (e.g., application X 56, application Y 58) to the communication device 53 in response to receipt of the request.

The installation manager 52 (e.g., installation manager 71) may map the source entities (e.g., an organization (e.g., origin entity X, origin entity Y)) of the applications (e.g., application X 56, application Y 58), detected during installation, to a virtual domain from which the applications (e.g., application X 56, application Y 58) are provided. In this example embodiment, the application X 56 provided from source origin entity X (e.g., Company X) may include one or more permissions (e.g., permission Z). On the other hand, the application Y 58 provided from source origin entity Y (e.g., Company Y) may not include any permissions.

In the example embodiment of FIG. 10, an application installation package may be digitally signed, which may allow the installation manager 52 to determine the source entity (e.g., organization) of a corresponding application (e.g., application X 56, application Y 58). The installation manager 52 may utilize information provided with an application from a source entity (e.g., an organization) to create a corresponding virtual domain. In this regard, in an instance in which the installation manager 52 determines that several applications originate from the same source entity (e.g., organization), the installation manager 52 may place the applications into the same virtual domain. For instance, in the example embodiment of FIG. 10, the installation manager 52 may analyze information of the application X 56 and may determine that application X 56 originated from source entity X. As such, the installation manager 52 may place application X in a virtual domain for source entity X (also referred to herein as virtual site of entity X) (e.g., company X)). Additionally, the installation manager 52 may analyze information of the application Y 58 and may determine that application Y 58 originated from source entity Y (also referred to herein as virtual site of entity Y) (e.g., company Y).

By utilizing this approach, the installation manager 52 may achieve a desired effect of separating applications into different virtual domains such that one or more browsers (e.g., browser 60) (e.g., or third party browsers) loading the applications (e.g., application X 56, application Y 58) may separate the applications into their own sandboxes according to browser security principles, as described more fully below.

During installation, the installation manager 52 may ask a user of the communication device 53 whether a permission (e.g., permission Z) requested by an application (e.g., application X 56) is granted and in an instance in which the permission is granted, the installation manager 52 may store the granted permission(s) in a memory. The server 54 may link or associate the granted permission(s) to a token that is generated for the application (e.g., application X 56). In the example embodiment of FIG. 10, one or more applications (e.g., application X 56, application Y 58) installed to communication device 53 may be loaded, or provided, via network 32 to the browser 60 of communication device 55.

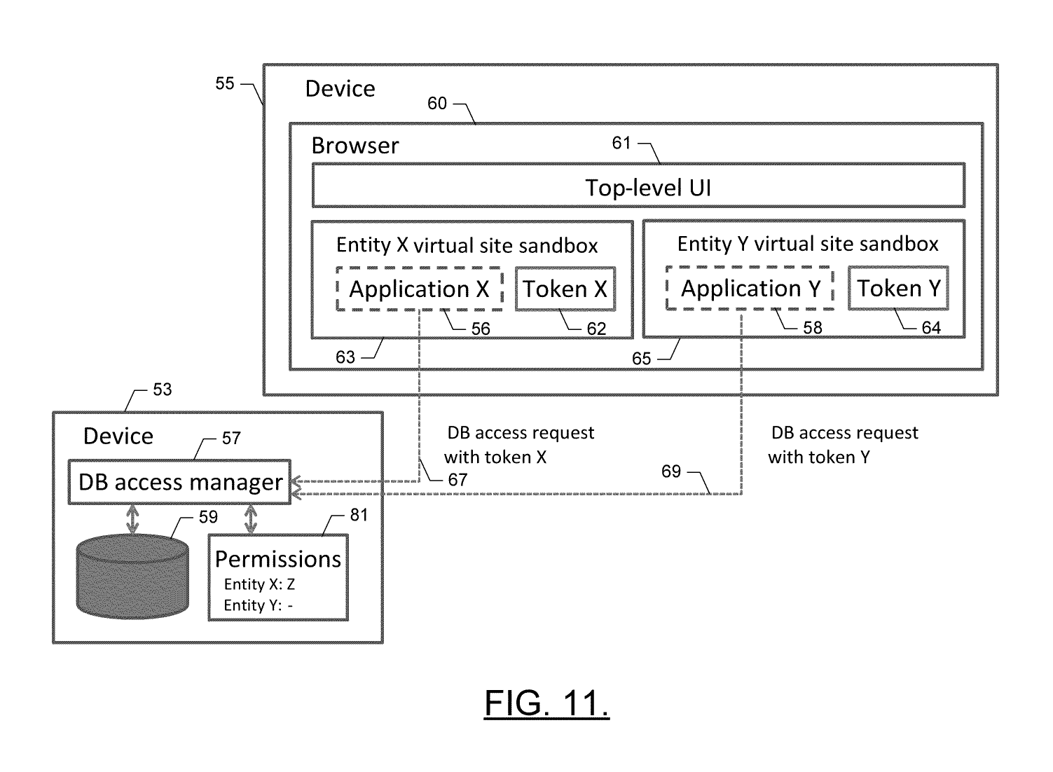

Referring now to FIG. 11, a diagram illustrating communication devices verifying access request origins according to an example embodiment is provided. In the example embodiment of FIG. 11, in an instance in which one or more applications are loaded by a communication device 55 from communication device 53, a top-level UI 61 of a browser 60 may provide the corresponding tokens (e.g., token X 62, token Y 64) to the respective applications (e.g., application X 56, application Y 58). The top level UI 61 of the browser 60 may include the applications in their own sandboxes (e.g., entity X virtual site sandbox 63, entity Y virtual site sandbox 65) since the applications were included by the server 54 (of the communication device 54) in different virtual domains indicating that each of the applications (e.g., application X 56, application Y 58) have different source origins (e.g., source entity X, source entity Y).

In the example embodiment of FIG. 11, the top level UI 61 of the browser 60 may not provide a token to an application in an instance in which the token and a corresponding application are not placed securely in their corresponding sandbox by the top level UI 61. In an instance in which an application (e.g., application X 56) makes a security-critical request(s) (e.g., DB access request 67) (also referred to herein as DB access request with token X) to a database or memory (e.g., memory 59 (e.g., memory device 76)) of the communication device 53, the DB access manager 57 may analyze the information of the request and may determine an application permission(s) (e.g., permission Z) based on the provided token (e.g., token X 62). The permissions may grant access to one or more resources on communication device 53.

In the example embodiment of the systems of FIGS. 10 and 11, the installation manager 52 may create virtual sites to server 54 depending on the origin of an application (e.g., based on an indication of an origin field of an application package). In addition, the top level UI 61 of a browser 60 of the communication device 55 may separate applications into their own sandboxes such that the DB access manager 57 of the communication device 53 may securely verify access request origins and match origin permissions, as described above.

For instance, as shown in FIG. 10, the server 54 of the communication device 53 may provide one or more applications (e.g., web applications) to a browser (e.g., browser 72) of communication device 53 or to a browser 60 of communication device 55. The server 54 may receive the applications (e.g., application X 56, application Y 58) from one or more network devices (e.g., network device 51). The server 54 may determine the origin of the applications and may create one or more virtual domains based on determining the origin. In one example embodiment, the server 54 may determine the origin (e.g., source origin entity X) of an application(s) by analyzing an origin field of an application package associated with the application(s) (e.g., application X 56) that is received from a network device(s) (e.g., network device 51). In this regard, applications determined by the server 54 to have the same origin may be placed in the same virtual domain by the server 54. On the other hand, applications determined by the server 54 to have different origins may be placed in respective different virtual domains.

For instance, in the example of FIG. 10, the server 54 may determine that the received application X 56 has an origin (source origin entity X) that is different than from the received application Y 58. As such, the server 54 may include the application X 56 in a virtual domain such as virtual site of entity X 77 and may include application Y 58 in a different virtual domain such as virtual site of entity Y 79. In this manner, the server 54 may serve or provide applications from created virtual domains (e.g., virtual site of entity X 77, virtual site of entity Y 79). Additionally, the server 54 may generate and provide a domain-specific security token for a corresponding application(s) in an instance in which an application(s) is loaded (e.g., loaded or provided to a browser 60 of communication device 55). In this regard, the server 54 may enable the top level UI 61 running in the browser 60 to generate links to one or more installed applications which may make it easier for a user to launch an application(s) (e.g., application X 56, application Y 58).

The installation manager 52 may detect a source origin (e.g., an organization or company (e.g., Nokia)) from an application digital signature of a received application(s) (e.g., application X 56, application Y 58). As described above, the application(s) may be received from one or more network devices (e.g., network device 51). Additionally, the installation manager 52 may detect one or more application permission requirements (e.g., permission Z) from application installation package meta-data associated with an application (e.g., application X 56). The installation manager 52 may prompt a user to accept one or more permissions (e.g., permission Z) for an installable application(s) (e.g., application X 56). Moreover, the installation manager 52 may facilitate storage, in a memory (e.g., memory 59) of the granted permissions for an application(s) into a permission registry. The installation manager 52 may also instruct the server 54 to create a virtual domain and copy or include a corresponding application in a virtual domain. The installation manager 52 may create one or more links (e.g., associated with an icon) to an installed application(s) into a top level UI (e.g., top level UI 75) running in a browser (e.g., browser 72).

The DB access manager 57 may receive one or more access requests (e.g., DB access request 67, DB access request 69) from a communication device (e.g., communication device 55). The access requests sent by a top level UI 61 of a communication device (e.g., communication device 53) to the DB access manager 57 may include one or more tokens granting permissions to resources. The tokens (e.g., token X 62, token Y 64) may be retrieved by the top level UI 61 from one or more corresponding sandboxes (e.g., entity X virtual site sandbox 63, entity Y virtual site sandbox 65). In response to receiving an access request (e.g., access request 67) requiring a permission(s) (for example to resources (e.g., memory, processing capacity, operating system resources, etc.) on the communication device 53), the request is may be checked by the DB access manager 57 for a security token(s). In this regard, the DB access manager 57 may query the server 54 to check for which virtual domain (e.g., virtual site of entity X 77) the token (e.g., token X 62) is provided. The determined virtual domain may then be checked by the DB access manager 57 against a permission registry (e.g., permission registry 81) (also referred to herein as permissions 81). In an instance in which the DB access manager 57 determines that a virtual domain is not allowed to perform a requested operation, the request may be denied by the DB access manager 57. In addition, in an instance in which an access request does not include a token, the DB access manager 57 may deny the request. In an example embodiment, the DB access manager 57 may send the top level UI 61 a message indicating that an access request is denied.

In the example embodiment of FIGS. 10 and 11, the browser 60 (e.g., a web browser) may able to load top-level UIs and applications from another communication device such as, for example, communication device 53, as described above. The browser 60 may have one or more security features, which separate code loaded from different origins into separate sandboxes (e.g., entity X virtual site sandbox 63, entity Y virtual site sandbox 65).

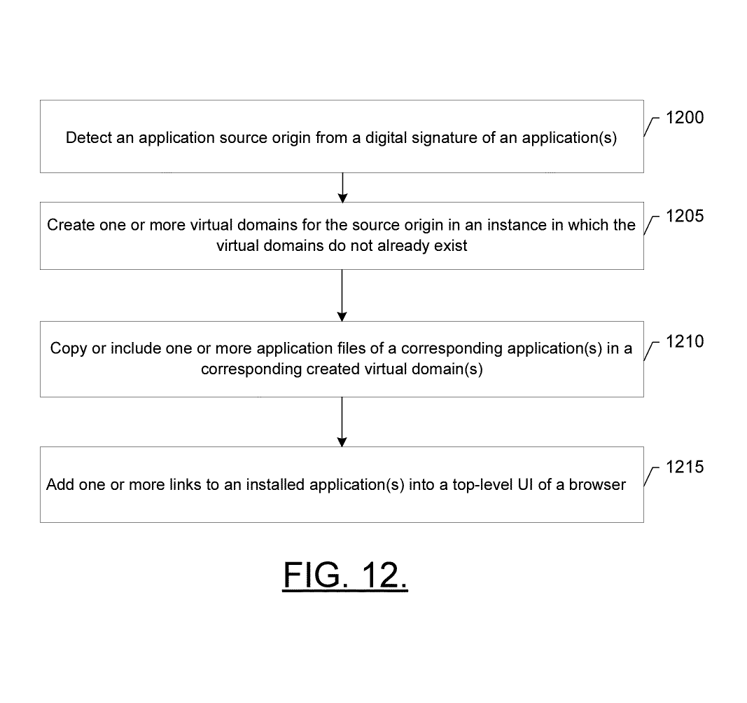

Referring now to FIG. 12, a flowchart of an example method of installing an application according to an example embodiment is provided. At operation 1200, an apparatus (e.g., communication device 53 (e.g., apparatus 50)) may detect an application source origin (e.g., an organization (e.g. Nokia™)) from a digital signature of an application(s). At operation 1205, an apparatus (e.g., communication device 53) may create one or more virtual domains (e.g., virtual site of entity X 77, virtual site of entity Y 79) for the source origin (source origin entity X, source origin entity Y) in an instance in which the virtual domains do not already exist.

At operation 1210, an apparatus (e.g., communication device 53) may copy or include one or more application files of a corresponding application(s) (e.g., application X 56, application Y 58) in a corresponding created virtual domain(s) (e.g., virtual site of entity X 77, virtual site of entity Y 79). At operation 1215, an apparatus (e.g., communication device 53) may add one or more links to an installed application(s) into a top-level UI (e.g., top level UI 75, top level UI 61) running in a browser (e.g., browser 72, browser 60). In this regard, a user may click an application link in top-level UI to load a corresponding application(s) (e.g., application X 56, application Y 58). As such, a browser may load an application(s) (e.g., application X 56, application Y 58) from a virtual domain (e.g., virtual site of entity X 77, virtual site of entity Y 79) that may be provided by a server (e.g., server 54). As such, a browser (e.g., browser 72) may limit application access to a virtual domain in accordance with the same-origin policy.

In an alternative example embodiment, access control to a communication device such as, for example, communication device 53 may be done by using a token(s) (e.g., token X 62, token Y 64) that is provided to an application(s) (e.g., application X 56, application Y 58) running in a corresponding virtual site sandbox (e.g., entity X virtual site sandbox 63, entity Y virtual site sandbox 65). As such, in this example embodiment, the application may be responsible for keeping the token(s) safe. The application (or a convenience library that the application uses for database access) may need to provide the token(s) with each access request (e.g., access request 67, access request 69) to a DB access manager (e.g., DB access manager 57).

In another alternative example embodiment, database access or access to other resources (e.g., memory, processing capacity, etc.) may be performed through a top-level UI (which resides in its own sandbox). In this regard, the sandbox may be implemented with an inline frame (iframe), which may allow communicating to another iframe using a mechanism referred to as postMessage( ). The postMessage( ) may allow securely determining the origin domain of the message, which means that a top-level UI may determine which application sandbox created an access request message. The top level UI may then add a token corresponding to the application sandbox to an access request message.

An example embodiment of the invention may be different from existing approaches in that virtual domains of the example embodiment may be allocated during application installation. Additionally, an example embodiment may be different from existing approaches in that one or more permissions may be associated with or tied to a virtual domain-specific token and a server of a communication device may manage access to security-critical resources based on the virtual domain-specific token.

In another alternative example embodiment, virtual domains maybe dynamically managed such as, for example, allowing an application to be served from a different domain each time an application is loaded. In this regard, a domain manager may allocate domains based on the situation, for example, by putting all untrusted applications into a single domain, even in an instance in which space of a memory of a communication device (e.g., communication device 55) is running out (the browser (e.g., browser 60) of the communication device may have memory overhead for maintaining separate domains). On the other hand, not having fixed domains may, but need not, complicate application development in some instances, as web applications are commonly using features like local storage and cookies that rely on static origin.

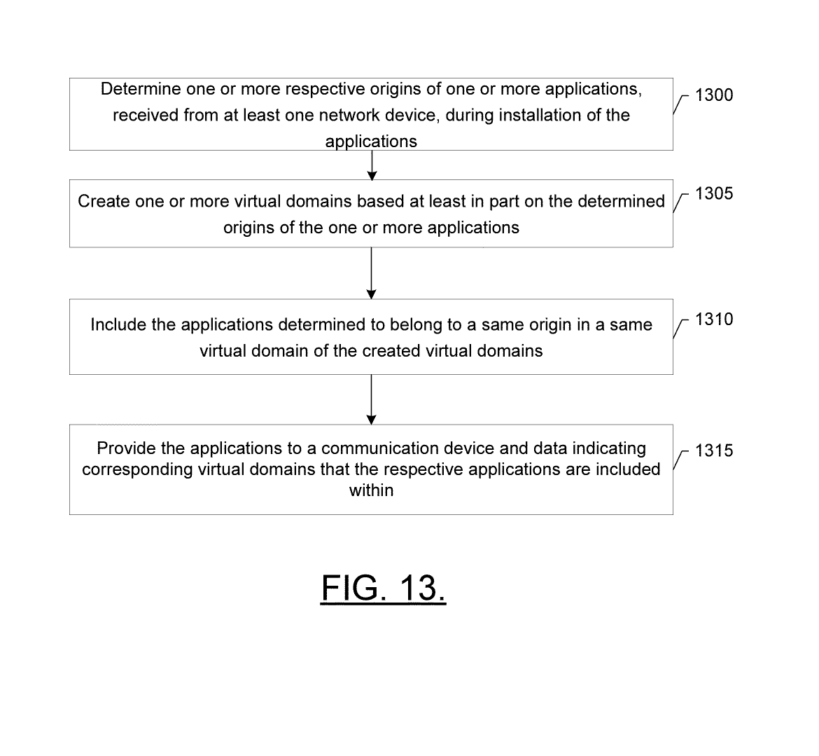

Referring now to FIG. 13, an example embodiment of a flowchart for determining origins of applications is provided. At operation 1300, an apparatus (e.g., communication device 53 (e.g., apparatus 50)) may determine one or more respective origins (e.g., source origin entity X, source origin entity Y) of one or more applications (e.g., application X 56, application Y 58), received from at least one network device (e.g., network device 51), during installation of the applications. At operation 1305, the apparatus (e.g., communication device 53) may create one or more virtual domains (e.g., virtual site of entity X 77, virtual site of entity Y 79) based at least in part on the determined origins of the applications.

At operation 1310, the apparatus (e.g., communication device 53) may include one or more applications determined to belong to a same origin (e.g., source origin entity X 56) in a same virtual domain (e.g., virtual site of entity X 77) of the created virtual domains. At operation 1315, the apparatus (e.g., communication device 53) may provide one or more of the applications, to a communication device (e.g., communication device 55 (e.g., apparatus 50)) and data indicating corresponding virtual domains (e.g., virtual site of entity X 77, virtual site of entity Y 79) that the respective applications are included within. The data may include a generated token(s) (e.g., token X 62, token Y 64) that enables a corresponding application(s) (e.g., application X 56, application Y 58) to access one or more resources (e.g., a database, a memory, processing capacity, operating system resources, etc.).

It should be pointed out that FIGS. 12 and 13 are flowcharts of a system, method and computer program product according to an example embodiment of the invention. It will be understood that each block of the flowcharts, and combinations of blocks in the flowcharts, may be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, processor 94). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 12 and 13 above may comprise a processor (e.g., the processor 70, the processor 94) configured to perform some or each of the operations (1200-1215, 1300-1315) described above. The processor may, for example, be configured to perform the operations (1200-1215, 1300-1315) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1200-1215, 1300-1315) may comprise, for example, the processor 70 (e.g., as means for performing any of the operations described above), the DB access manager 78, the installation manager 71, the browser 72, the top level UI 75, the server 73, the processor 94 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining one or more respective origins of one or more applications, received from at least one network device, during installation of the one or more applications;
creating one or more virtual domains based at least in part on the determined origins of the one or more applications;
including, via a processor, the applications determined to belong to a same origin in a same virtual domain of the created virtual domains; and
enabling provision of the applications, to a communication device and data indicating corresponding virtual domains that the respective applications are included within, the data comprises a generated token that enables a corresponding application to access one or more resources.

2. The method according to claim 1, further comprising:
receiving one or more access requests from a browser of the communication device, the access requests requesting at least a subset of the resources on behalf of the respective applications in an instance in which each of the respective applications are included in a corresponding sandbox that is designated to include applications within a same virtual domain that originate from the same origin.

3. The method according to claim 2, further comprising:
enabling provision of the subset of the resources to the respective applications of the communication device in response to detecting respective tokens in the access requests, the respective tokens allow access to the subset of resources based on one or more permissions granted to the respective applications.

4. The method according to claim 3, wherein the subset of resources comprise at least one of a database, a memory, or processing capacity.

5. The method according to claim 2, further comprising:
denying at least one of the requests in response to determining that the at least one request does not include a token.

6. The method according to claim 3, further comprising:
denying at least one of the requests in response to determining that a virtual domain associated with a token, among the respective tokens, is disallowed from performing a requested operation indicated in at least one of the requests.

7. (canceled)

8. The method according to claim 1, wherein prior to enabling provision, the method further comprises:
determining whether one or more permissions to the resources are associated with the corresponding application during the installation; and
generating the token associated with the corresponding application in response to receipt of an indication that the permissions are accepted.

9. The method according to claim 8, wherein prior to determining whether the permissions to the resources are associated with the respective resources, the method further comprises:
detecting permission requirements of the corresponding application from meta-data of an application package associated with the corresponding application.

10. (canceled)

11. (canceled)

12. The method according to claim 1, wherein enabling provision to the communication device comprises enabling the communication device to include the respective applications of the corresponding virtual domains in one or more respective different sandboxes such that each of the different sandboxes include a subset of the respective applications from the same origin.

13. An apparatus comprising:
at least one processor; and
at least one memory including computer program code, the at least one memory and the computer program code configured to, with the at least one processor, cause the apparatus to perform at least the following:
determine one or more respective origins of one or more applications, received from at least one network device, during installation of the one or more applications;
create one or more virtual domains based at least in part on the determined origins of the one or more applications;
include the applications determined to belong to a same origin in a same virtual domain of the created virtual domains; and
enable provision of the applications, to a communication device and data indicating corresponding virtual domains that the respective applications are included within, the data comprises a generated token that enables a corresponding application to access one or more resources.

14. The apparatus according to claim 13, wherein the at least one memory and the computer program code are further configured to, with the processor, cause the apparatus to:
receive one or more access requests from a browser of the communication device, the access requests requesting at least a subset of the resources on behalf of the respective applications in an instance in which each of the respective applications are included in a corresponding sandbox that is designated to include applications within a same virtual domain that originate from the same origin.

15. The apparatus according to claim 14, wherein the at least one memory and the computer program code are further configured to, with the processor, cause the apparatus to:
enable provision of the subset of the resources to the respective applications of the communication device in response to detecting respective tokens in the access requests, the respective tokens allow access to the subset of resources based on one or more permissions granted to the respective applications.

16. The apparatus according to claim 15, wherein the subset of resources comprise at least one of a database, a memory, or processing capacity.

17. The apparatus according to claim 14, wherein the at least one memory and the computer program code are further configured to, with the processor, cause the apparatus to:
deny at least one of the requests in response to determining that the at least one request does not include a token.

18. The apparatus according to claim 15, wherein the at least one memory and the computer program code are further configured to, with the processor, cause the apparatus to:
deny at least one of the requests in response to determining that a virtual domain associated with a token, among the respective tokens, is disallowed from performing a requested operation indicated in at least one of the requests.

19. (canceled)

20. The apparatus according to claim 13, wherein prior to enable provision, the at least one memory and the computer program code are further configured to, with the processor, cause the apparatus to:
determine whether one or more permissions to the resources are associated with the corresponding application during the installation; and
generate the token associated with the corresponding application in response to receipt of an indication that the permissions are accepted.

21. The apparatus according to claim 20, wherein prior to determine whether the permissions to the resources are associated with the respective resources, the at least one memory and the computer program code are further configured to, with the processor, cause the apparatus to:
detect permission requirements of the corresponding application from meta-data of an application package associated with the corresponding application.

22. (canceled)

23. (canceled)

24. The apparatus according to claim 13, wherein the at least one memory and the computer program code are further configured to, with the processor, cause the apparatus to:
enable provision to the communication device by enabling the communication device to include the respective applications of the corresponding virtual domains in one or more respective different sandboxes such that each of the different sandboxes include a subset of the respective applications from the same origin.

25. A computer program product comprising at least one non-transitory computer-readable storage medium having computer-executable program code instructions stored therein, the computer-executable program code instructions comprising:
program code instructions configured to determine one or more respective origins of one or more applications, received from at least one network device, during installation of the one or more applications;
program code instructions configured to create one or more virtual domains based at least in part on the determined origins of the one or more applications;
program code instructions configured to include the applications determined to belong to a same origin in a same virtual domain of the created virtual domains; and
program code instructions configured to enable provision of the applications, to a communication device and data indicating corresponding virtual domains that the respective applications are included within, the data comprises a generated token that enables a corresponding application to access one or more resources.

26. The computer program product according to claim 25, further comprising:
program code instructions configured to facilitate receipt of one or more access requests from a browser of the communication device, the access requests requesting at least a subset of the resources on behalf of the respective applications in an instance in which each of the respective applications are included in a corresponding sandbox that is designated to include applications within a same virtual domain that originate from the same origin.

27.-48. (canceled)
